(19) United States
(12) Patent Application Publication
(10) Pub. No.: US 2007/0065666 A1
(43) Pub. Date: Mar. 22, 2007

(54) Driving gear used to transmit power

(76) Inventors: Michael Keller, Nuertingen (DE); Lutz Wolkober, Gertringen (DE)

Correspondence Address: DREISS, FUHLENDORF, STEIMLE & BECKER, POSTFACH 10 37 62, D-70032 STUTTGART, DE

(21) Appl. No.: 10/575,849

(22) PCT Filed: Nov. 2, 2004
(86) PCT No.: PCT/EP04/12364

§ 371 Date: Apr. 14, 2006

(30) Foreign Application Priority Data
Nov. 3, 2003 (DE) 103 51 258.6

(51) Int. Cl. B32B 9/00

(52) U.S. Cl. 428/408

(57) ABSTRACT

The invention relates to a driving gear used to transmit power, especially a toothed gear for machine tools. Said driving gear is produced from a warm-hardened-steel having a ferritie or pearlitic structure and a base hardness of the uncoated surface of at least 25 HRC, and a hard surface coating with a thickness of less than 10 μm.

The invention relates to a driving gear used to transmit power, in particular, a toothed wheel for machine tools made from steel.

Driving gears, e.g. of electric tools have a limited service life due to their high power consumption. In most cases, the cause of defects is wear of the toothed profiles of the armature toothing. Although harder toothed profiles could reduce toothing wear, this cannot be achieved in an economic fashion using conventional steel hardening methods. Since the wear of a toothing is, in principle, limited to the surface of the toothed profiles, the toothed profiles could be provided with a hard, wear-resistant layer. Such layers are deposited using plasma methods and are much harder than conventionally hardened steel.

Toothed wheels of previously hardened steel have conventionally been provided with an additional hard coating of this type and/or with a tribologically effective, low-friction functional layer. Since such coatings are very thin, it was assumed that only previously hardened steel can be used as a basis for the coating. A ferritic or perlitic structure is converted into a martensitic structure through extensive thermal treatment to harden the steel and thereby convert the structure.

Departing therefrom, it is the object of the present invention to improve a power transmitting driving gear of the above-mentioned type in such a manner that it can be produced in an economic fashion, while still having sufficient wear resistance to meet the requirements.

This object is achieved in accordance with the invention by a power transmitting driving gear, in particular, a toothed wheel for tools made from a non-hardened steel having a ferritic or perlitic structure and a base hardness of the uncoated steel surface of at least 25 HRC and with a hard surface coating having a thickness of less than 10 μm.

The invention therefore proposes the production of driving gears not from hardened, in particular, case-hardened steel, which is e.g. provided with a further hard and wear-resistant layer deposited using the plasma method, rather deliberately from a steel which is not thermally hardened but has a high base strength.

It has also turned out in accordance with the invention that a conventional hard surface coating can also improve the hardness and wear resistance of driving gears made from unhardened steel of the type claimed in such a manner that they meet the usual requirements with regard to service life. Despite the use of unhardened steel which has, however, the claimed base hardness, there is no so-called “egg shell effect”, i.e. that the surface coating is penetrated under point load.

Although it has been previously assumed that unhardened steel is not suited for the production of power transmitting driving gears, the present invention has shown that this is not true for steel of sufficient base hardness.

The layers deposited by the plasma can considerably increase the toothed profile hardness and wear resistance and therefore the service life of driving gears made from unhardened steel of the type claimed. Since the natural base strength of the unhardened steel of the type claimed is sufficient to avoid the egg shell effect, hardening of the steel is not necessary. The productions costs are thereby reduced, while simultaneously increasing the quality of the components. The tolerances with respect to shape, position and dimensions are more precise, since warping due to hardening does not occur.

It is e.g. feasible to obtain the required base strength of at least 25 HRC (measured with 1470 N test load), in particular of 25 to 35 HRC, in particular 26 to 35 HRC, preferentially 27 to 35 HRC and in particular 27 to 30 HRC, through pulling or drawing the steel, i.e., not by thermal hardening, rather while maintaining the ferritic or perlitic structure.

Steel with 0.4 to 0.5 mass % carbon, 1.13 to 1.70 mass % manganese, 0.2 to 0.35 mass % sulphur, and optional silicon and phosphor has proven to be advantageous. The high base strength of such a steel is due to embedded manganese sulphides which, being disposed on the surface, have a stress concentration effect, leading to insufficient stability even after subsequent (thermal) hardening. For this reason, unhardened steel was not previously used to produce driving gears, which are subjected to high loads. However, it has now been determined that the hard surface coating covers the manganese sulphides in the surface region, which are detrimental due to their notching effects, and renders them harmless. Despite the use of steel of the above-mentioned type which is unhardened per se, no “egg shell effect” is observed. The manganese sulphides produce a sufficiently high base strength of the unhardened steel of the composition claimed.

The coating may also be low-friction, such that less frictional heat is produced on the driving gear, in particular, at its toothed structures. A WCH coating (tungsten-carbon-hydrogen) or a DLC (diamond like carbon) or a W-DLC (tungsten-diamond like carbon) or a CrN (chromium nitride) coating or a combination of these coatings are advantageously used as the surface coating.

It has turned out that a surface coating of a thickness of 2 to 8, in particular, 3 to 7, and preferably 4 to 6 μm is sufficient.

These above-mentioned Rockwell hardness values do not reach the value of 50 to 65 HRC of e.g. case-hardened 16MnCrS5Pb or 16MnCr5 steels but come sufficiently close to these hardness values that satisfactory operation is ensured. The above-mentioned Rockwell hardness values are, however, higher than those of unhardened M16MnCrS5 steel.

The surface of the inventive coated driving gear may furthermore have a microhardness HV 0.03 of at least HV 1200, in particular of at least HV 1250. The micro hardness is measured with a sufficiently small test load so that it actually represents the hardness of the surface coating, i.e.:, the test body does not penetrate through the surface coating.

A combined coating of CrN/DLC and CrN/W-DLC has turned out to be particularly advantageous. Not only the micro hardness but also the wear resistance and the friction properties are improved compared to uncoated driving gears produced from hardened, in particular, case-hardened steels.

1-6. (canceled)

7. A driving gear or a toothed wheel for power transmission in tools, the gear comprising:
a non-thermally hardened steel body having ferritic or perlitic structure and an uncoated surface hardness of at least 25 HRC; and
a hard surface coating disposed on said steel body, said coating having a thickness of less than 10 μm.

8. The driving gear of claim 7, wherein said steel body comprises embedded manganese sulphides and 0.4 to 0.5 mass % carbon, 1.13 to 1.70 mass % manganese, and 0.2 to 0.35 mass % sulphur.

9. The driving gear of claim 8, wherein said steel body comprises silicon and phosphor.

10. The driving gear of claim 7, wherein said surface coating is WCH, DLC, W-DLC, CrN, or combinations thereof.

11. The driving gear of claim 7, wherein said surface coating has a thickness of 2 to 10 μm.

12. The driving gear of claim 11, wherein said thickness is 3 to 7 μm.

13. The driving gear of claim 7, wherein said uncoated surface has a Rockwell hardness of 25 to 35 HRC, 26 to 35 HRC, 27 to 35 HRC, or of 27 to 30 HRC.

14. The driving gear of claim 7, wherein said hard surface coating has a micro hardness HV 0.03 of at least HV 1200 or of at least HV 1250.
